(19) United States
(12) Patent Application Publication
(10) Pub. No.: US 2026/0065445 A1
(43) Pub. Date: Mar. 5, 2026

(54) METHOD AND APPARATUS FOR CORRECTING DISTORTION OF AN IMAGE

(71) Applicants: HYUNDAI MOTOR COMPANY, Seoul (KR); KIA CORPORATION, Seoul (KR)

(72) Inventor: Min Chul Kang, Hwaseong-si (KR)

(73) Assignees: HYUNDAI MOTOR COMPANY, Seoul (KR); KIA CORPORATION, Seoul (KR)

(21) Appl. No.: 19/228,712

(22) Filed: Jun. 4, 2025

(30) Foreign Application Priority Data
Aug. 30, 2024 (KR) 10-2024-0117280

(51) Int. Cl. G06T 5/80; B60R 1/27; G06T 5/50; H04N 23/698; H04N 23/90

(52) U.S. Cl. CPC G06T 5/80; B60R 1/27; G06T 5/50; H04N 23/698; H04N 23/90; B60R 2300/105; B60R 2300/303; B60R 2300/304; B60R 2300/306; B60R 2300/607; G06T 2207/10024; G06T 2207/30252

(57) ABSTRACT

A method for correcting distortions of an image includes generating Around View Monitoring (AVM) image data from images input from two or more cameras installed around a vehicle; determining whether adjacent overlapping regions due to discontinuities exist in the AVM image data; determining a first homography matrix according to a point transformation of a user region of interest (ROI) based on a predetermined point, based on the adjacent overlapping regions existing; modifying the first homography matrix to a second homography matrix according to a point transformation of a modified user ROI based on the predetermined point; determining whether visibility conditions are satisfied according to a modification result; and modifying the second homography matrix to a third homography matrix according to a re-modified user ROI based on the predetermined point, based on the visibility conditions not being satisfied.

### CROSS-REFERENCE TO RELATED APPLICATION

The present application claims priority to Korean Patent Application No. 10-2024-0117280, filed on Aug. 30, 2024, the entire contents of which is incorporated herein for all purposes by this reference.

### TECHNICAL FIELD

The present disclosure relates to a method and an apparatus for correcting distortions of an image.

### BACKGROUND

The content described below provides background information related to the present disclosure and does not constitute the prior art.

An Around View Monitoring (AVM) system employs a technique that installs a plurality of cameras around a vehicle, captures images of the front, rear, left, and right sides of the vehicle, and then synthesizes the images captured from the front, rear, left, and right sides of the vehicle to display them as a single image. A vehicle driver may observe the surroundings of the vehicle as if looking down from above the vehicle, through which the vehicle driver may maintain safety during driving or parking.

FIGS. 1A, 1B, 2A, and 2B illustrate cases where discontinuities are present in the surroundings of a driving vehicle and where no discontinuities are present.

Both FIGS. 1A and 1B show a synthesized image obtained from wide-angle cameras positioned at the front and side of a vehicle.

FIG. 1A is a synthesized image from front/side wide-angle cameras when no discontinuities are present. FIG. 1B is a synthesized image of front/side wide-angle cameras when discontinuities are present. \textcircled{1} of FIG. 1B corresponds to the area captured by the front camera, and \textcircled{2} of FIG. 1B corresponds to the area captured by the side camera. Distortions occur in the intersecting areas or boundaries of images 1 and \textcircled{2} of FIG. 1B due to height differences (discontinuities), such as a road curb or an obstacle.

Both FIGS. 2A and 2B show 3D images obtained from synthesis of omnidirectional (front/rear/left/right) wide-angle camera images.

FIG. 2A is a 3D image synthesized from omnidirectional (front/rear/left/right) wide-angle camera images when no discontinuities are present in the surroundings. FIG. 2B is a 3D image synthesized from omnidirectional (front/rear/left/right) wide-angle camera images when discontinuities are present. \textcircled{1} of FIG. 2B corresponds to the area captured by the front camera, and \textcircled{2} of FIG. 2B corresponds to the area captured by the side area. Distortions occur in the intersecting areas or boundaries of images \textcircled{1} and \textcircled{2} of FIG. 2B due to height differences (discontinuities), such as a road curb or an obstacle.

When discontinuities are present due to height differences, such as a road curb or an obstacle, in an omnidirectional 3D image or a magnified 2D image of a specific area (front/rear top view) obtained by editing the front, side (left/right), and rear wide-angle camera images, AVM images display error components when images are stitched (edited) according to each camera and viewpoint direction, which causes inconvenience since an additional correction process is required for the final image containing the error components.

### SUMMARY

In situations where discontinuities are present due to height differences, such as a road curb or an obstacle, in an omnidirectional 3D image or a magnified 2D image of a specific area (front/rear top view) obtained by editing the front, side (left/right), and rear wide-angle camera images, the present disclosure provides a method and an apparatus for correcting distortions in the image.

Technical problems to be solved by the present disclosure are not limited to those mentioned above, and other technical problems not mentioned may be apparent to a person having ordinary knowledge in the technical field to which the present disclosure pertains (i.e., a person having ordinary skill in the art) from the following detailed description of the present disclosure.

According to an embodiment of the present disclosure, a method includes generating Around View Monitoring (AVM) image data from images input from two or more cameras installed around a vehicle; determining whether adjacent overlapping regions due to discontinuities exist in the AVM image data; calculating or determining a first homography matrix according to a point transformation of a user region of interest (ROI) based on a predetermined point, based on the adjacent overlapping regions existing (i.e., if/when the adjacent overlapping regions exist in the AVM image data); modifying the first homography matrix to a second homography matrix according to a point transformation of a modified user ROI based on the predetermined point; determining whether visibility conditions are satisfied according to a modification result; and modifying the second homography matrix to a third homography matrix according to a re-modified user ROI based on the predetermined point, based on the visibility conditions not being satisfied (i.e., if/when the visibility conditions are not satisfied).

According to an embodiment of the present disclosure, an apparatus for correcting distortions of an image includes: a memory including commands; and a processor executed by the commands, wherein the processor is configured to: generate Around View Monitoring (AVM) image data from images input from two or more cameras installed around a vehicle; determine whether adjacent overlapping regions due to discontinuities exist in the AVM image data; calculate or determine a first homography matrix according to a point transformation of a user region of interest (ROI) based on a predetermined point, based on the adjacent overlapping regions existing (i.e., if/when the adjacent overlapping regions exists); modify the first homography matrix to a second homography matrix according to a point transformation of a modified user ROI based on the predetermined point; determine whether visibility conditions are satisfied according to a modification result; and modify the second homography matrix to a third homography matrix according to a re-modified user ROI based on the predetermined point, based on the visibility conditions not being satisfied (i.e., if/when the visibility conditions are not satisfied).

When discontinuities are present due to height differences, such as a road curb or an obstacle, in an omnidirectional 3D image or a magnified 2D image of a specific area (front/rear top view) obtained by editing the front, side (left/right), and rear wide-angle camera images, the present disclosure may correct the image distortions due to the discontinuities.

Even when discontinuities are present due to height differences, such as a road curb or an obstacle, the present disclosure maintains high quality of AVM images.

Effects to be obtained from the present disclosure are not limited to those mentioned above, and other effects not mentioned are apparent to one having ordinary skill in the art to which the present disclosure belongs from the following description.

### BRIEF DESCRIPTION OF THE DRAWINGS

FIGS. 1A, 1B, 2A, and 2B illustrate cases where discontinuities are present in the surroundings of a driving vehicle and where no discontinuities are present.

FIG. 3 illustrates a process of generating a top view image.

FIGS. 4 and 5 illustrate an image stitching process.

FIG. 6 illustrates a coordinate system of the ground plane reference.

FIG. 7 illustrates a projective transformation process of the ground plane reference.

FIGS. 8, 9, and 10 illustrate homography composition of the ground plane reference.

FIGS. 11A, 11B, 12A, and 12B illustrate examples of image warping.

FIGS. 13A, 13B, 13C, 13D, and 13E are examples of top view images applied to the present disclosure.

FIGS. 14 and 15 illustrate a method for correcting distortions of an image according to an embodiment of the present disclosure.

FIGS. 16, 17, 18, and 19 illustrate an image analysis process for adjacent overlapping regions.

FIGS. 20A, 20B, and 20C illustrate a method for correcting distortions of an image according to an embodiment of the present disclosure.

FIG. 21 illustrates a process of generating a top view image applied to the present disclosure.

FIG. 22 illustrates a process of homography matrix transform (H₁) applied to an embodiment of the present disclosure.

FIG. 23 illustrates a process of homography matrix transform (H₂) applied to an embodiment of the present disclosure.

FIGS. 24A and 24B illustrates item 1 of criteria for determining satisfaction of visibility according to an embodiment of the present disclosure.

FIGS. 25A and 25B illustrates item 2 of criteria for determining satisfaction of visibility according to an embodiment of the present disclosure.

FIG. 26 illustrates item 3 of criteria for determining satisfaction of visibility according to an embodiment of the present disclosure.

FIG. 27 illustrates item 4 of criteria for determining satisfaction of visibility according to an embodiment of the present disclosure.

FIG. 28 is a flow diagram illustrating a method for correcting distortions of an image according to an embodiment of the present disclosure.

FIG. 29 illustrates an example of transforming a ground plane reference according to an embodiment of the present disclosure.

FIG. 30 illustrates original front/rear/left/right images.

FIG. 31 illustrates an example of an AVM image corrected for the effects of discontinuities.

FIG. 32 illustrates a case of a front top-view image where the original front/rear/left/right images and AVM image are corrected for the distortions due to discontinuities.

FIG. 33 illustrates a case of a common/3D top view image where the original front/rear/left/right images and AVM image are corrected for the distortions due to discontinuities.

FIG. 34 is a block diagram of an image distortion correction apparatus according to an embodiment of the present disclosure.

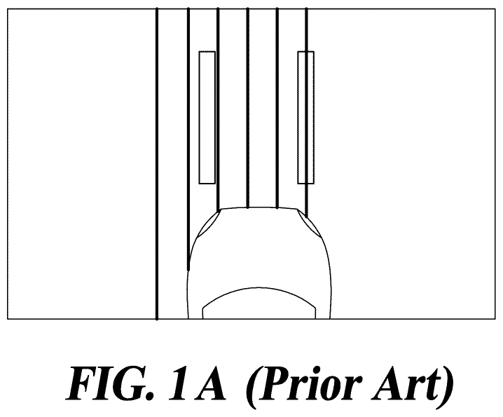

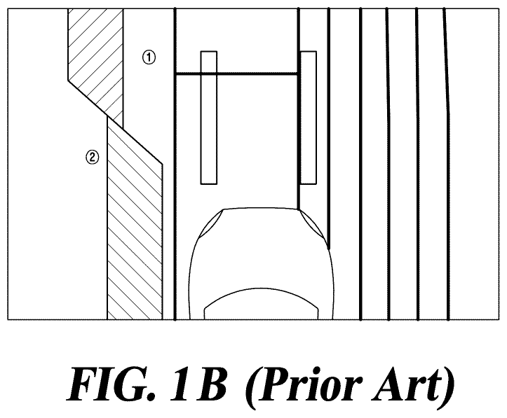

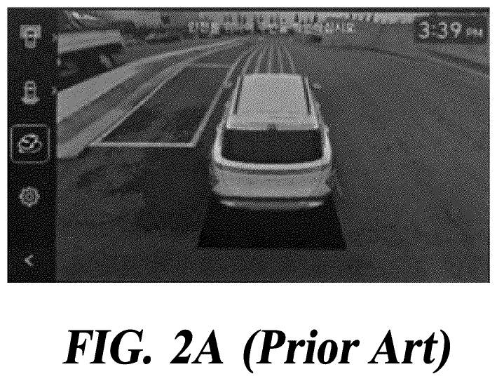

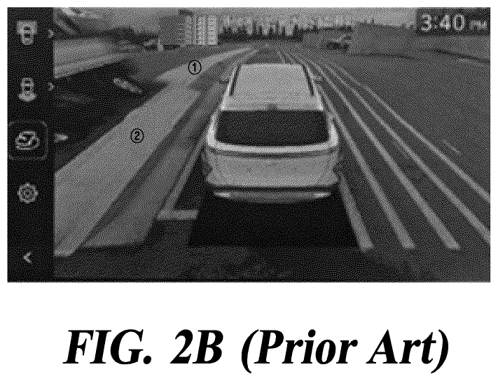

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to embodiments of the present disclosure, examples of which are illustrated in the accompanying drawings and described below. While the present disclosure is described in conjunction with embodiments of the present disclosure, it should be understood that the present description is not intended to limit the present disclosure to those embodiments of the present disclosure. The present disclosure is intended to cover not only the embodiments of the present disclosure, but also various alternatives, modifications, equivalents and other embodiments, which may be included within the spirit and scope of the present disclosure as defined by the appended claims.

Hereinafter, embodiments of the present disclosure are described in detail with reference to the accompanying drawings. In the following description, like reference numerals refer to like elements even though the elements are shown in different drawings. In the following description of embodiments of the present disclosure, a detailed description of known functions and configurations incorporated therein have been omitted for the purpose of clarity and for brevity.

Furthermore, terms such as first, second, A, B, (a), (b) may be used to describe components of the present disclosure. These terms are intended only to distinguish one component from another, and the nature, sequence, or order of the components is not limited by the terms. Throughout the specification, whenever any part is said to “include,” “have” or “comprise” any component, it is meant to be inclusive of other components, not exclusive of other components, unless specifically stated to the contrary. Furthermore, terms such as “part,” “module,” and the like in the specification refer to a unit that handles at least one function or operation, which may be implemented in hardware or software or a combination of hardware and software. When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer readable media, as part of the apparatus.

The following detailed description, together with the accompanying drawings, is intended to illustrate embodiments of the present disclosure and is not intended to represent the only embodiments in which the present disclosure may be practiced.

The term “user view region of interest” (user ROI) refers to a specific area within the image that is selected or calculated based on a user's viewing direction or viewpoint, and which serves as a basis for generating a perspective-transformed image.

The correction of distortions in an image according to the present disclosure includes correcting distortions due to discontinuities in the image, and the image according to the present disclosure includes an AVM image.

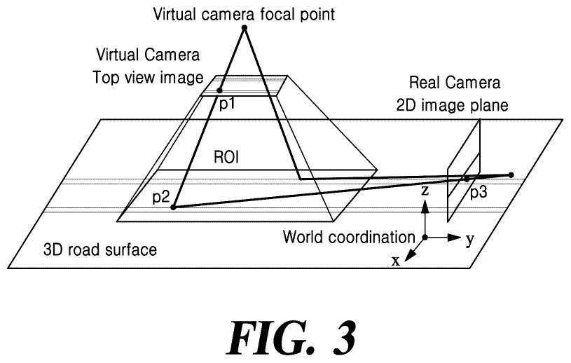

FIG. 3 illustrates a process of generating a top view image.

Referring to FIG. 3, p1 represents top view image coordinates of a virtual camera, p2 represents the world coordinates of an arbitrary point in the region of interest (ROI), and p3 represents the image coordinates of an actual camera.

The top view image coordinates correspond to actual 3D world coordinates, where the coordinate system of the top view image is matched one-to-one to the world coordinate system.

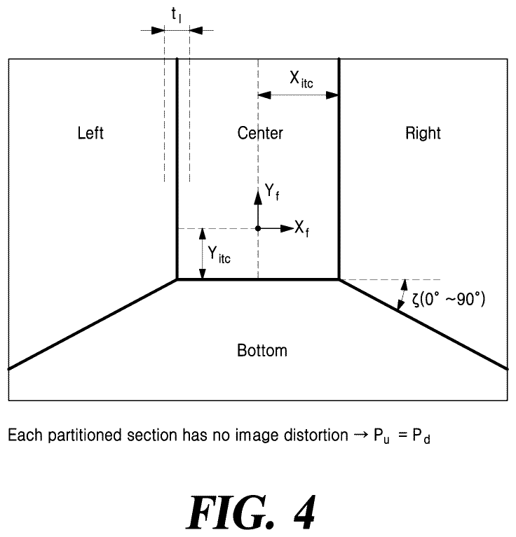

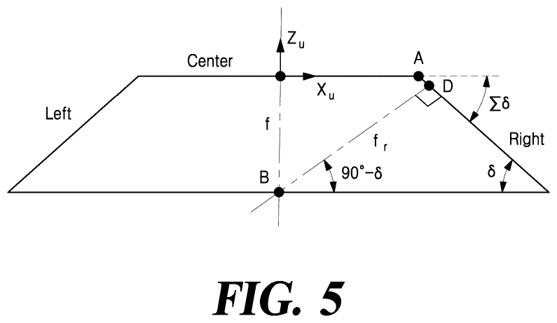

FIGS. 4 and 5 illustrate an image stitching process.

Referring to FIG. 4, individual boundary areas of the AVM image may be denoted as left, center, right, and bottom images. FIG. 4 shows an example where stitching is performed between the right and center images.

First, as shown in FIG. 5, the coordinates of A and D are calculated by Equation 1 below with reference to the (Xᵤ, Zᵤ) coordinate system.

$$A : ( {X}_{i t c} , 0 ) = ( {X}_{u A} , {Z}_{uA} ) \qquad [ Equation 1 ]$$

$$D : ( {X}_{uD} , {Z}_{uD} )$$

The coordinates of point D at which lines AD and BD intersect may be obtained as follows.

Referring to FIG. 5, AD represents a line passing point A with an orientation of −δ degrees and satisfies Equation 2 below.

$${Z}_{u} = - tan δ \cdot ( {X}_{u} - {X}_{uA} ) \qquad [ Equation 2 ]$$

Referring to FIG. 5, BD represents a line passing point B (0, −f) with an orientation of 90°−δ degrees and satisfies Equation 3 below.

$${Z}_{u} = cot δ \cdot {X}_{u} - f = - tan δ \cdot {X}_{u} + {X}_{uA} \cdot tan δ = cot δ \cdot {X}_{u} - f \qquad [ Equation 3 ]$$

Since the coordinates of point D at which lines AD and BD intersect are calculated with reference to the (Xᵤ, Zᵤ) coordinate system, Equation 4 below may be satisfied.

$${X}_{uD} = ( {X}_{u A} \cdot tan δ + f ) / ( tan δ + cot δ ) , {Z}_{uD} = ( cot δ \cdot {X}_{u D} ) - f \qquad [ Equation 4 ]$$

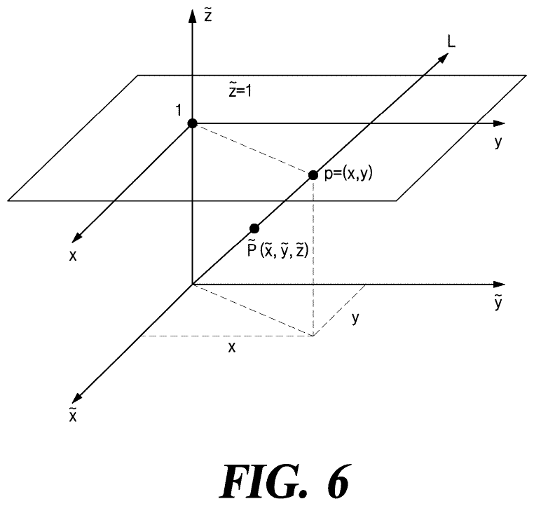

FIG. 6 illustrates a coordinate system of the ground plane reference and represents the homogeneous coordinate system.

The homogeneous expression of a 2D point p=(x, y) is a 3D point \tilde{p}(\tilde{x}, \tilde{y}, \tilde{z}) where \tilde{z}≠0, and \tilde{z} is an imaginary (fictitious) coordinate.

x, y of FIG. 6 may be expressed by Equation 5 below.

$$x = \tilde{x} / \tilde{z} , y = \tilde{y} / \tilde{z} \qquad [ Equation 5 ]$$

The relationship between points p and \tilde{p} of FIG. 6 may be expressed by Equation 6 below.

$$p ≡ [ x ; y ; 1 ] ≡ [ \hat{z} x ; \hat{z} y ; \hat{z} ] ≡ [ \tilde{x} ; \tilde{y} ; \tilde{z} ] = \tilde{p} \qquad [ Equation 6 ]$$

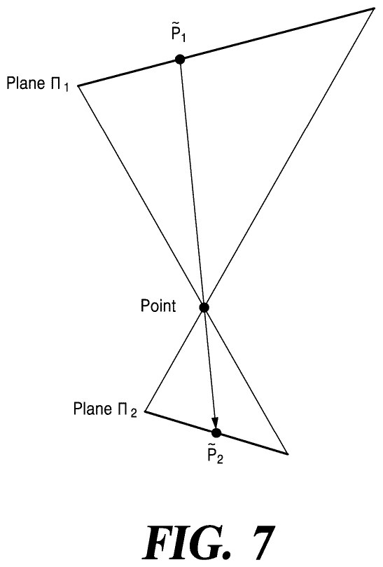

FIG. 7 illustrates a projective transformation process of the ground plane reference.

Projective transformation represents a point transformation from one plane to another plane. The plane images seen through the pinhole remain the same. The relationship between points \tilde{p}₁ and \tilde{p}₂ of FIG. 7 may be expressed by Equation 7 below.

$${\tilde{p}}_{2} = H \cdot {\tilde{p}}_{1} , [ {\tilde{x}}_{2} ; {\tilde{y}}_{2} ; {\tilde{z}}_{2} ] = [ [ {h}_{11} {h}_{12} {h}_{13} ] ; [ {h}_{21} {h}_{22} {h}_{23} ] ; [ {h}_{31} {h}_{32} {h}_{33} ] ] [ {\tilde{x}}_{1} ; {\tilde{y}}_{1} ; {\tilde{z}}_{1} ] \qquad [ Equation 7 ]$$

The scale of homography may be defined by Equation 8 below.

$$[ [ {h}_{11} {h}_{12} {h}_{13} ] ; [ {h}_{21} {h}_{22} {h}_{23} ] ; [ {h}_{31} {h}_{32} {h}_{33} ] ] \times [ {\tilde{x}}_{1} ; {\tilde{y}}_{1} ; {\tilde{z}}_{1} ] ≡ [ {\tilde{x}}_{2} ; {\tilde{y}}_{2} ; {\tilde{z}}_{2} ] ≡ k \times [ [ {h}_{11} {h}_{12} {h}_{13} ] ; [ {h}_{21} {h}_{22} {h}_{23} ] ; [ {h}_{31} {h}_{32} {h}_{33} ] ] \times [ {\tilde{x}}_{1} ; {\tilde{y}}_{1} ; {\tilde{z}}_{1} ] \qquad [ Equation 8 ]$$

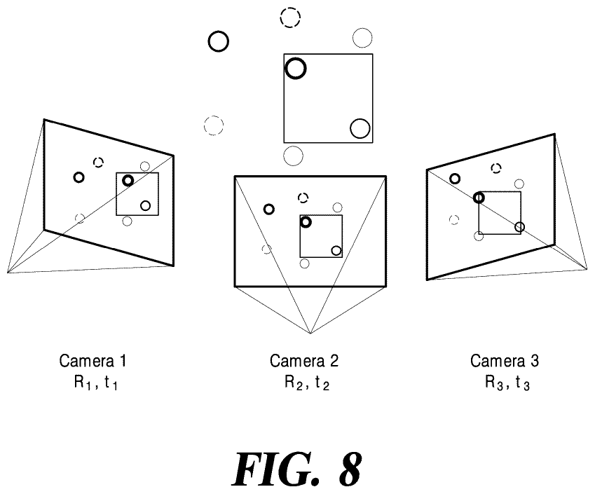

FIGS. 8, 9, and 10 illustrate homography composition of the ground plane reference.

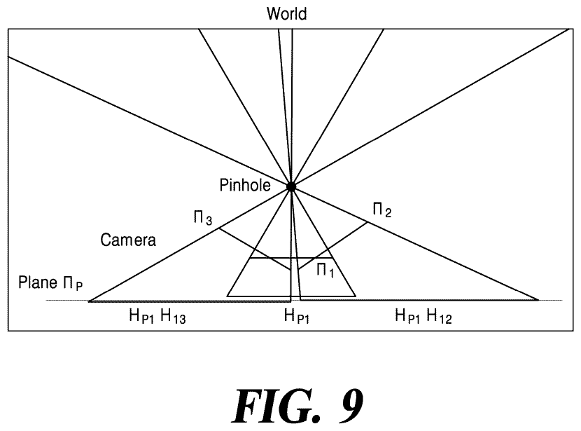

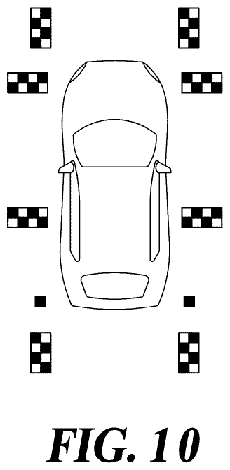

FIG. 8 illustrates the operation of projecting each camera image onto the same plane. FIG. 9 illustrates the projection of FIG. 8 in the same coordinate system. FIG. 10 shows plane features detected from an AVM image.

To merge each camera image into a panoramic image, all images have to be projected onto the same plane. To make this possible, as shown in FIG. 8, the images have to form a homography relationship. Homography composition is useful in image stitching, commonly used to create panoramic images.

As shown in FIG. 9, the most important factor in creating a panoramic image is to estimate accurate homography. The fundamental requirement for creating a panoramic image is based on an assumption that when the 3D real world is projected onto a 2D image plane of the camera, projected images are on the same plane. Homography is a 3×3 matrix that represents the relationship between points in the reference image and corresponding points in the target image. For reference, tolerance correction is performed using the checkerboard of FIG. 10, where the tolerance correction is performed by transforming pixels with respect to the floor surface.

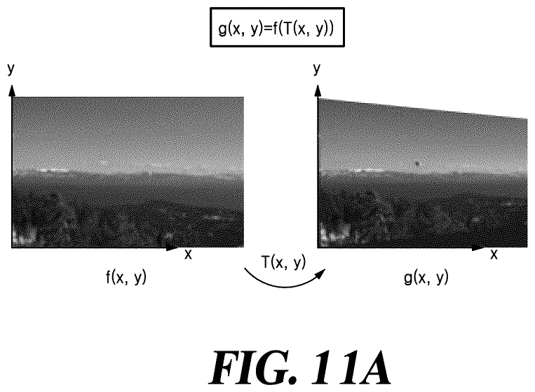

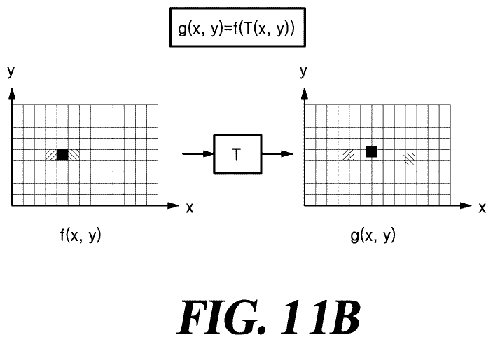

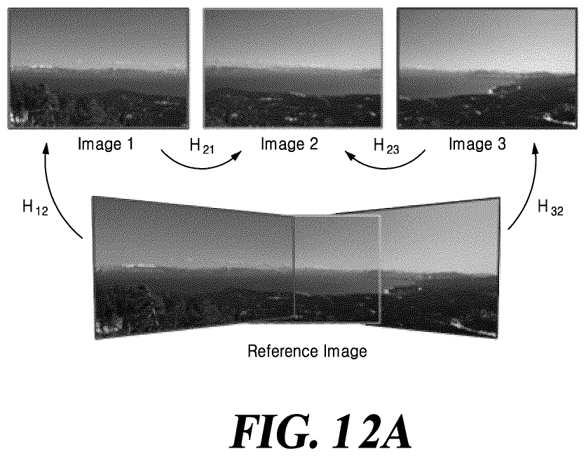

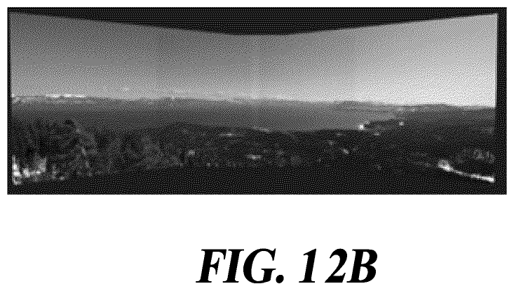

FIGS. 11A, 11B, 12A, and 12B illustrate examples of image warping.

Image warping refers to changing only the pixel positions of the original image. More specifically, image warping is a method for correcting optical or mechanical distortions in display devices, such as projection TVs, projectors, and monitors, by applying spatial transformation.

If an image f (x, y) and a transformation T are given as shown in FIG. 11A, a transformed image g (x, y) may be calculated as shown in FIG. 11B.

Referring to FIG. 12A, pixels may be transformed into their corresponding positions, and inverse transformations are also possible. For example, forward warping and backward warping may be used as methods for correcting distortions of an image, but the present disclosure is not limited to the specific techniques.

FIG. 12B is an image obtained by synthesizing image 1, image 2, and image 3 of FIG. 12A through the stitching process.

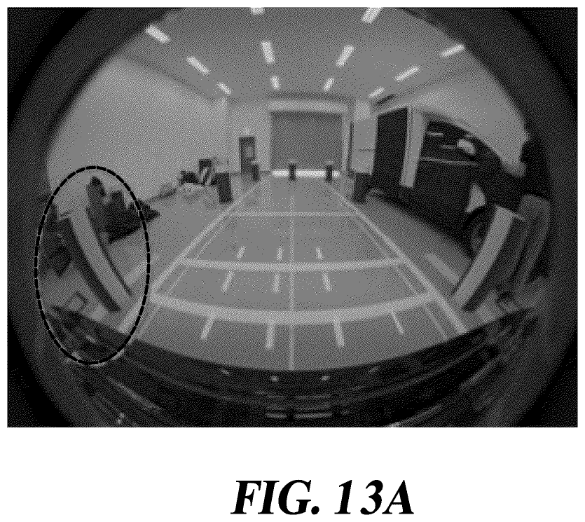

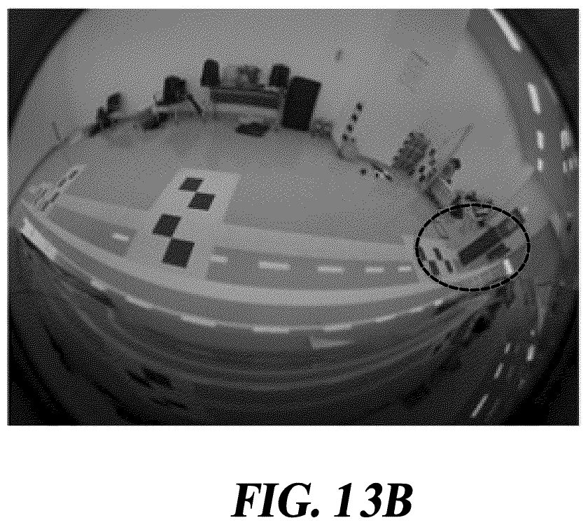

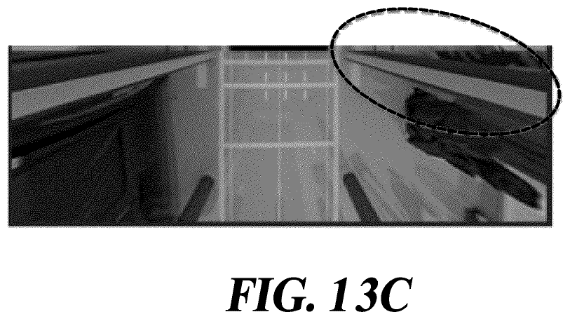

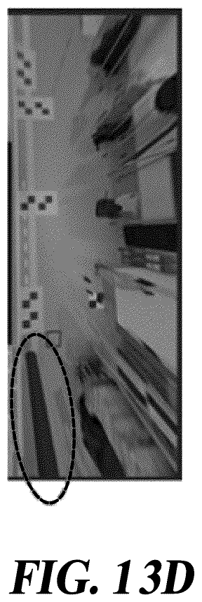

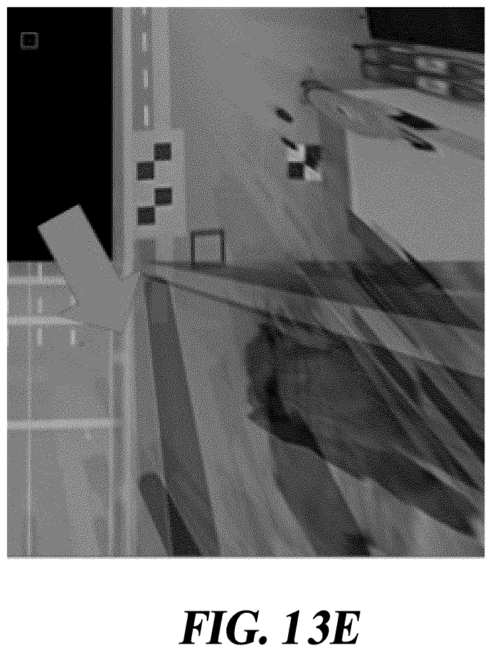

FIGS. 13A, 13B, 13C, 13D, and 13E are examples of top view images applied to the present disclosure.

FIG. 13A represents the original rear image, and FIG. 13B represents the original side image. FIG. 13E shows a case in which simple blending is applied to overlapping adjacent images in the adverse situation.

Comparing the original image with FIGS. 13A, 13B, 13C, 13D, and 13E reveals that the same object appears differently (or viewed in a different direction) in each image depending on the mounting positions and orientations of the respective cameras.

The top view is generated by transforming the viewpoint and projecting the original image onto the plane (ground) assuming that the camera viewpoint is perpendicular to the ground. Each pixel of the top view drawn on the plane is mapped from the corresponding pixel of the original image; if the pixel corresponding to the ground is occluded by a vertical object, the vertical object may appear in the ground area, as shown in FIG. 13E. Therefore, as shown in FIG. 13E, the same vertical object appears completely different in the top view of each camera, requiring correction for improved visibility and a proper operation to discontinuities in the image.

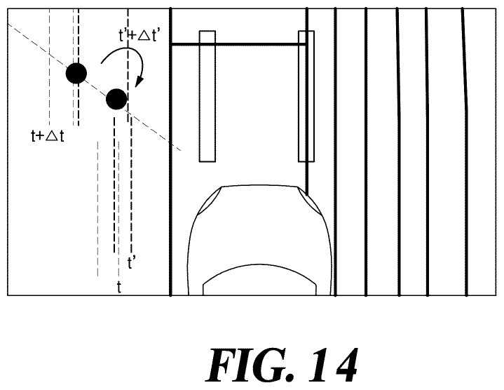

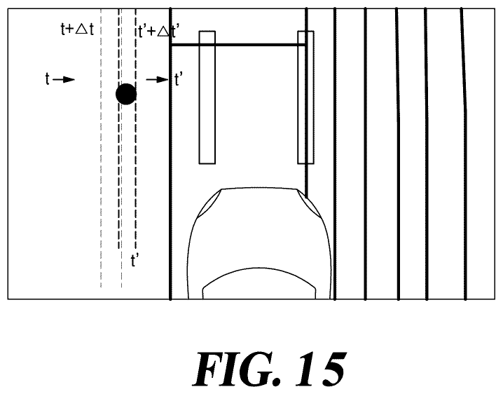

FIGS. 14 and 15 illustrate a method for correcting distortions of an image according to an embodiment of the present disclosure.

FIG. 14 shows an example where discontinuities are generated in the image, and FIG. 15 shows an example where pixels are moved after the discontinuities are corrected. Referring to FIGS. 14 and 15, the transformation matrix from t to t′ may be expressed by Equation 13 described below.

The apparatus for correcting distortions of an image moves pixels to the corresponding points using the side view image as a reference, which yields smaller error from matrix transformation between two image coordinates, and determines the scale and depth of a specific image region where the image discontinuities have occurred.

The apparatus for correcting distortions of an image calculates discontinuity correction information (e.g., translation and rotation) for specific pixels based on the scale and depth.

The apparatus for correcting distortions of an image translates pixels and reduces/enlarges the pixel sizes by identifying image regions in which RGB values as well as gradients (vectors) between adjacent image pixels change abruptly. In an embodiment of the present disclosure, the image distortion correction apparatus determines the presence of an adjacent overlapping region when changes in RGB values as well as gradients (vectors) between adjacent image pixels are below a threshold. The gradient is calculated along both the x-axis and y-axis at each pixel; the x-axis and the y-axis are different axes that are orthogonal to each other, but the present disclosure is not limited to the specific example.

The image distortion correction apparatus performs a smoothing operation between the corrected images. The smoothing operation includes, but is not limited to, an alpha blending method and a brightness equalization process. A detailed description of the alpha blending method and the brightness equalization process has been omitted.

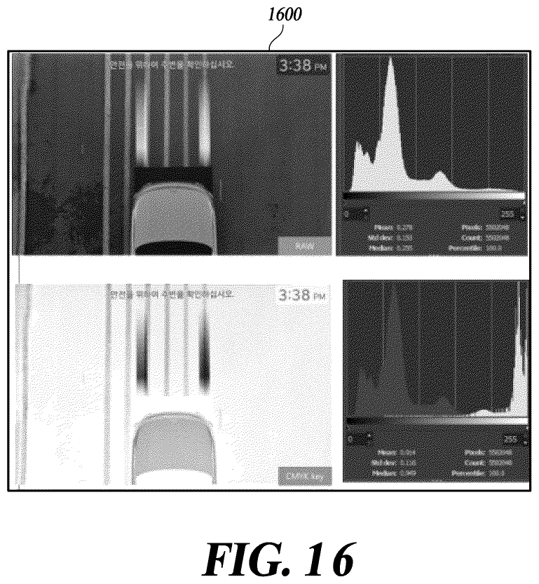

FIGS. 16, 17, 18, and 19 illustrate an image analysis process for adjacent overlapping regions.

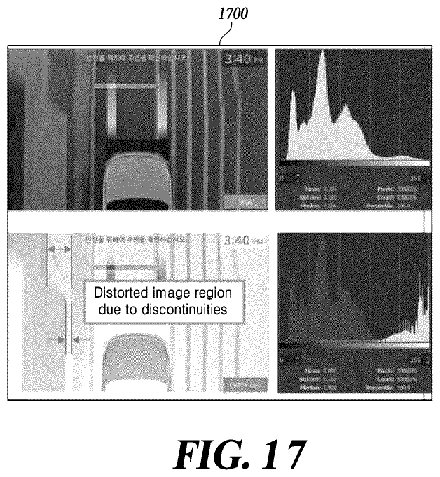

FIG. 16 is an example of an AVM image 1600 when no discontinuity is present. FIG. 17 is an example of an AVM image 1700 when discontinuities are present. In the case of FIG. 17, the image regions distorted by the discontinuities originally have the same depth.

Referring to FIGS. 16 and 17, if the key component in CMYK (Cyan Magenta Yellow Key (Black)), black, is extracted at a similar histogram level based on a RAW image (unprocessed image) of RGB (red, green, blue) components, discrete components of adjacent overlapping regions (from the front and side cameras) may be contrasted. A CMYK color model has been introduced to combine primary color pigments. C represents cyan, M represents magenta, Y represents yellow, and K represents black key. While black ink may be used as the key component, other colors such as brown, blue, and white may also be used for the key component.

Referring to FIG. 17, the image region distorted by the discontinuity (adjacent overlapping region) refers to, but is not limited to, a portion of the image in which an image region captured by a front camera and an image region capture by a side camera are adjacent to each other and form a boundary region. For example, the adjacent overlapping region according to an embodiment of the present disclosure represents one of the whole or part of the boundary region between images of the front wide-angle camera and the left wide-angle camera of a vehicle, the whole or part of the boundary region between images of the front wide-angle camera and the right wide-angle camera, the whole or part of the boundary region between images of the rear wide-angle camera and the left wide-angle camera, and the whole or part of the boundary region between images of the rear wide-angle camera and the right wide-angle camera. Although the image may appear distorted due to the discontinuity, the original depth values across the adjacent regions remain consistent.

The image region distorted by the discontinuity does not fit to its corresponding image region when being matched one-to-one. Therefore, an embodiment of the present disclosure corrects the image distortions introduced by the discontinuity. A stitching process is required to correct the image distortions introduced by the discontinuities.

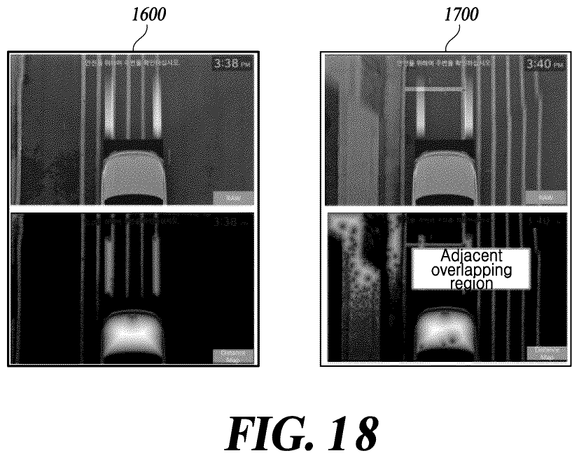

FIG. 18 shows an example where discontinuities are prominent in the adjacent overlapping region.

Reference number 1600 represents an AVM image when no discontinuities are present, and reference number 1700 represents an AVM image when discontinuities are present.

Referring to FIG. 18, if a distance transform is applied to the corresponding region for cross-checking, it is possible to check how far each pixel is from a specific subset of the binary image. The binary image is expressed as 0s or 1s. A distance map may be generated from the binary image, allowing the distance of each pixel in a non-subset region to the nearest pixel in the subset region to be determined. This process is useful in cases where an adjacent overlapping region and a prominent discontinuity are present.

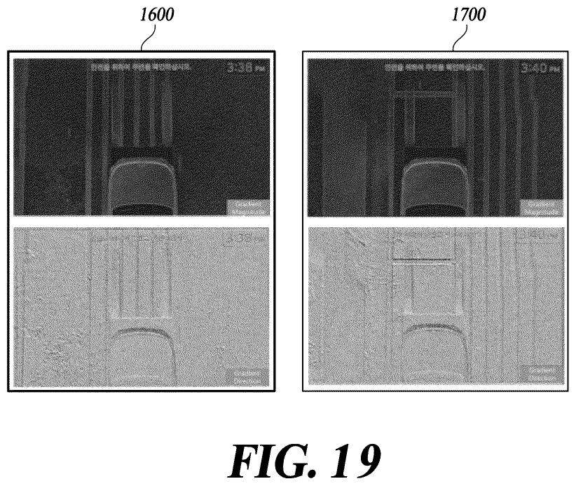

FIG. 19 shows an example of an image analysis process for adjacent overlapping regions.

The left drawing 1600 of FIG. 19 is an example of an image when no discontinuity occurs, and the right drawing 1700 of FIG. 19 is an example of an image when discontinuities are present.

The left drawing 1600 of FIG. 19 is an example of calculating gradient magnitudes and directions when no discontinuity occurs. The right drawing 1700 of FIG. 19 is an example of calculating gradient magnitudes and directions when discontinuities are present.

Referring to FIG. 19, given the influence of gradient direction on the edge direction, it appears that pixel values are greatly influenced. In other words, the direction of the edge is always perpendicular to the gradient direction. If a gradient vector is determined for each pixel as described above, a maximum change and a direction of the pixel may be calculated.

The gradient refers to a vector that is a collection of the first-order derivatives of a function with respect to each of its variables. When an image is assumed to be a function of variables x and y, the function value f(x, y) at (x, y) becomes the intensity value, and the image gradient may be defined by Equation 9 below.

$$∇ f ( x , y ) = [ \partial f ( x , y ) / \partial x ; \partial f ( x , y ) / \partial y ] \qquad [ Equation 9 ]$$

To describe the process of calculating the image gradient, a derivative filter is first selected. The derivative filter may include, for example, the Sobel filter.

The image distortion correction apparatus determines derivative functions to be applied to an image using convolution filters, as shown in S1 and S2 below. When image gradients are built using the derivative functions, gradient, direction, magnitude at each pixel may be calculated using the image gradients, as expressed in Equation 10 below.

$$S 1. \qquad [ Equation 10 ]$$

$$\begin{matrix}{s}_{x} = \vert \begin{matrix}1 & 0 & - 1\end{matrix} \vert \\ \vert \begin{matrix}2 & 0 & - 2\end{matrix} \vert \\ \vert \begin{matrix}1 & 0 & - 1\end{matrix} \vert\end{matrix} \\ \begin{matrix}{s}_{y} = \vert \begin{matrix}1 & 2 & 1\end{matrix} \vert \\ \vert \begin{matrix}0 & 0 & 0\end{matrix} \vert \\ \vert \begin{matrix}- 1 & - 2 & - 1\end{matrix} \vert\end{matrix}$$

$$S 2.$$

$$\partial f / \partial x = {S}_{x} ⊗ f , \partial f / \partial y = {S}_{y} ⊗ f$$

$$S 3.$$

$$∇ f = [ \partial f / \partial x , \partial f / \partial y ]$$

$$θ = {tan}^{- 1} ( ( \partial f / \partial y ) / ( \partial f / \partial x ) )$$

$$‖ ∇ f ‖ = √ [ {( \partial f / \partial x )}^{2} + {( \partial f / \partial y )}^{2} ]$$

Referring to Equation 10, the operation is performed sequentially in the order of S1, S2, and S3.

The gradient is denoted by ∇f of Equation 10, its direction is denoted by θ of Equation 10, and its magnitude is denoted by ∥∇f∥ of Equation 10.

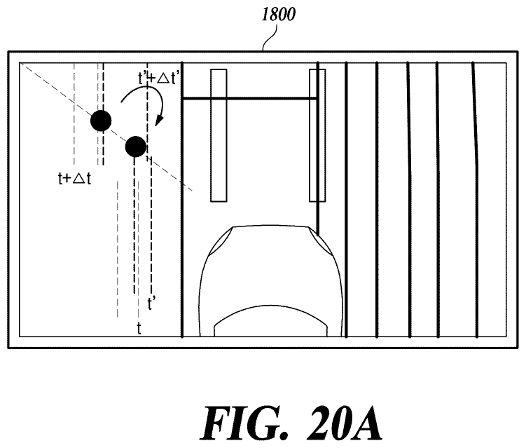

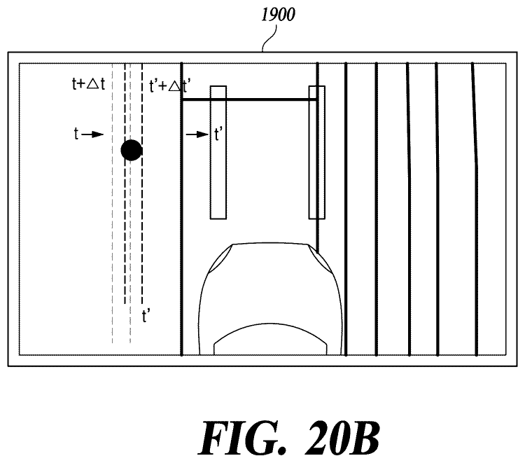

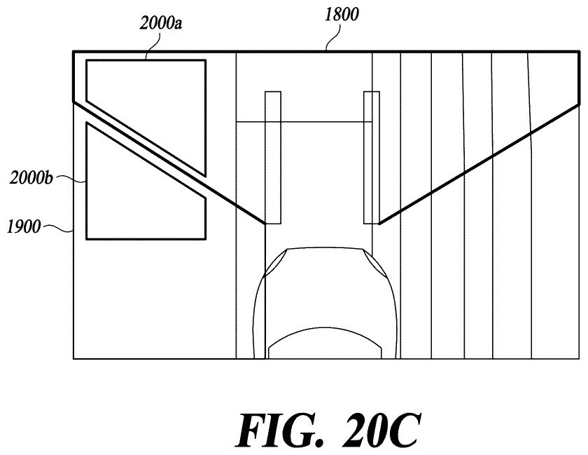

FIGS. 20A, 20B, and 20C illustrate a method for correcting distortions of an image according to an embodiment of the present disclosure.

FIGS. 20A and 20B show examples in which the image is distorted by the discontinuity Δt.

In the first region of FIG. 20A, the two points are in fact the same point to a human observer. Although the two points are at the same point of a corner, they appear to be two distinct points in the images captured by cameras at different viewpoints. If a homography matrix is applied to the outer point in the first region 1800 of FIG. 20A, the two points may be transformed to appear as a single point, as shown in the second region 1900 of FIG. 20B.

As a result of performing discontinuity correction on the image window of the third area 2000a and 2000b of FIG. 20C, pixels may be translated, and their sizes may be reduced/enlarged. As a result of performing discontinuity correction on the image window of the third area 2000a and 2000b of FIG. 20C, it may be seen that the lines of the third area 2000a and 2000b appear to be aligned.

FIG. 20C includes the first region 1800 of FIG. 20A and the second region 1900 of FIG. 20B. The first region 1800 and the second region 1900 of FIG. 20C include the third region 2000a and 2000b.

According to the image analysis of the adjacent overlapping region, as shown in the third region 2000a and 2000b of FIG. 20C, translation and reduction/enlargement of pixels may be performed through discontinuity correction of the image window.

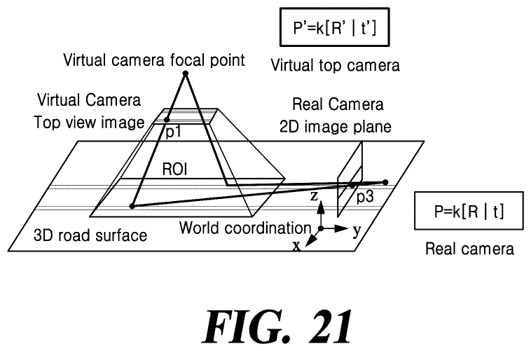

FIG. 21 illustrates a process of generating a top view image applied to the present disclosure.

The projection matrix between the actual camera and the virtual top view camera may be expressed by Equation 11 below.

$$P = K [ R \vert t ] {P}^{′} = K [ {R}^{′} \vert {t}^{′} ] \qquad [ Equation 11 ]$$

In Equation 11, K represents the intrinsic camera parameter matrix; R and R′ represent the rotation matrices; and t and t′ represent the translation vectors.

P represents the projection matrix of the actual camera, and P′ represent the projection matrix of a virtual camera (a virtual top camera or a virtual top view camera).

If ΔR is defined as a matrix transforming from R to R′, H_{ΔR} representing the homography matrix which projects an arbitrary point through ΔR may be expressed by Equation 12 below.

$${H}_{Δ R} = K ( Δ R ) {K}^{- 1} \qquad [ Equation 12 ]$$

The transform matrix from t to t′ may be expressed by Equation 13 below.

$$Δ t = {t}^{′} - t \qquad [ Equation 13 ]$$

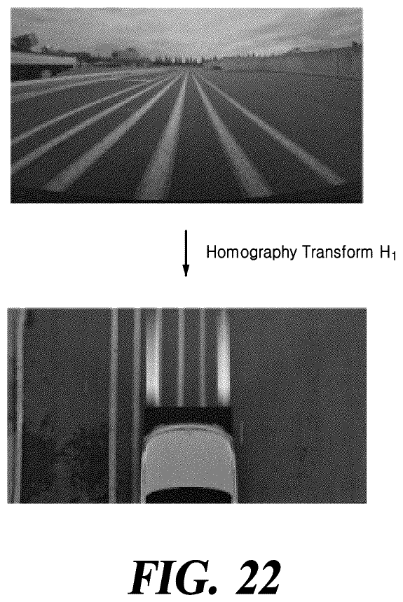

FIG. 22 illustrates a process of homography matrix transform (H₁) applied to an embodiment of the present disclosure.

Referring to FIG. 22, the homography matrix H₁ projects an image of a real camera from the user's viewpoint into a virtual top view image.

After calculating the homography matrix H₁, the image distortion correction apparatus predicts corresponding points for each pixel of the adjacent overlapping region between adjacent images and stitches the images from the front view camera and the side view camera based on the predicted corresponding points. The present disclosure is described with an example based on the front view camera and the side view camera; however, the present disclosure is not limited to the specific example.

The homography matrix transform H₁ according to an embodiment of the present disclosure may be expressed by Equation 14 below.

$$[ {x}_{d} ; {y}_{d} ; 1 ] ≡ [ {\tilde{x}}_{d} ; {\tilde{y}}_{d} ; {\tilde{z}}_{d} ] = [ [ {h}_{11} {h}_{12} {h}_{13} ] ; [ {h}_{21} {h}_{22} {h}_{23} ] ; [ {h}_{31} {h}_{32} {h}_{33} ] ] \times [ {x}_{s} ; {y}_{s} ; 1 ] \qquad [ Equation 14 ]$$

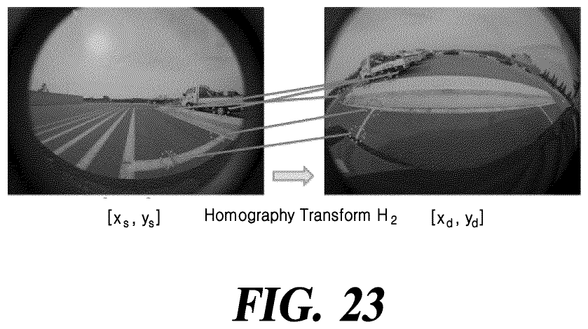

FIG. 23 illustrates a process of homography matrix transform H₂ applied to an embodiment of the present disclosure.

The homography matrix transform H₂ according to an embodiment of the present disclosure may be expressed by Equation 15 below.

$${x}_{d}^{( i )} = {\tilde{x}}_{d}^{( i )} / {\tilde{z}}_{d}^{( i )} = ( {h}_{11} \cdot {x}_{s}^{( i )} + {h}_{12} \cdot {y}_{s}^{( i )} + {h}_{13} ) / ( {h}_{31} \cdot {x}_{s}^{( i )} + {h}_{32} \cdot {y}_{s}^{( i )} + {h}_{33} ) {y}_{d}^{( i )} = {\tilde{y}}_{d}^{( i )} / {\tilde{z}}_{d}^{( i )} = ( {h}_{21} \cdot {x}_{s}^{( i )} + {h}_{22} \cdot {y}_{s}^{( i )} + {h}_{23} ) \text{} / ( {h}_{31} \cdot {x}_{s}^{( i )} + {h}_{32} \cdot {y}_{s}^{( i )} + {h}_{33} ) \qquad [ Equation 15 ]$$

If scaled stitching is performed as a result of applying the homography matrix transform H₂, and the visibility condition is not met, corresponding points are recalculated using the homography matrix transform

$${H}_{2}^{′} .$$

The homography matrix transform

$${H}_{2}^{′}$$

according to an embodiment of the present disclosure may be expressed by Equation 16 below.

$${x}_{d}^{( i )} \cdot ( {h}_{31} \cdot {x}_{s}^{( i )} + {h}_{32} \cdot {y}_{s}^{( i )} + {h}_{33} ) = {h}_{11} \cdot {x}_{s}^{( i )} + {h}_{12} \cdot {y}_{s}^{( i )} + {h}_{13} {y}_{d}^{( i )} \cdot ( {h}_{31} \cdot {x}_{s}^{( i )} + {h}_{32} \cdot {y}_{s}^{( i )} + {h}_{33} ) = {h}_{21} \cdot {x}_{s}^{( i )} + {h}_{22} \cdot {y}_{s}^{( i )} + {h}_{23} \qquad [ Equation 16 ]$$

Table 1 below shows an example describing criteria for determining whether a correction result according to an embodiment of the present disclosure satisfies the visibility condition. The overlapping region disclosed in Table 1 refers to the adjacent overlapping region.

The criteria for determining whether a correction result satisfies the visibility condition includes, but are not limited to, evaluation items, evaluation criteria, and criteria indices.

TABLE 1

| Evaluation | | | |
|---|---|---|---|
| No. | Evaluation item | Evaluation criterion | Criterion index |
| 1 | Scale variation in | The adjacent overlapping | Within 10% of |
| | corrected image | image region of a front view | scale error |
| | region | image is scale-adjusted with | |
| | | respect to a side view image, | |
| | | and translation/rotation error | |
| | | between pixels is permissible | |
| 2 | Continuity variation | Continuity is maintained | The same |
| | in corrected image | during linear interpolation | corner/edge |
| | region | after detection of corner/edge | detection |
| | | pixels of an adjacent | |
| | | overlapping image region | |
| 3 | Color information | The image tones in the | Within 10% of |
| | variation in corrected | adjacent overlapping regions | error for each RGB |
| | image region | are consistent, and errors | channel |
| | | during extraction of RGB | |
| | | properties are permissible | |
| 4 | Consistency of color | Differences of distance maps | Within 10% of |
| | tone in corrected | after the image correction in | distance error |
| | image region | the adjacent overlapping | |
| | | region are permissible | |
| 5 | Image region | Correction parameters for | Parameter |
| | reconstruction without | discontinuity compensation | switching within 1 |
| | discontinuity | should be updated differently | second |
| | | from the reconstruction | |
| | | parameters applied to the | |
| | | ground region (Is selective | |
| | | image processing applied such | |
| | | that original parameters are | |
| | | used for the reconstruction of | |
| | | the ground plane and | |
| | | correction parameters are | |
| | | applied to the image regions | |
| | | with discontinuities?) | |
| 6 | Applicability of image | When image correction is not | Immediate |
| | correction | feasible, fallback to parameters | provision of |
| | | before the correction. | fallback function |

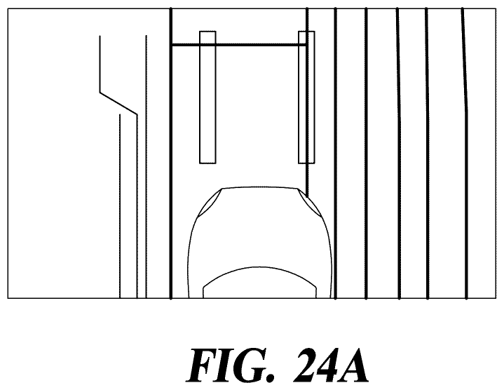

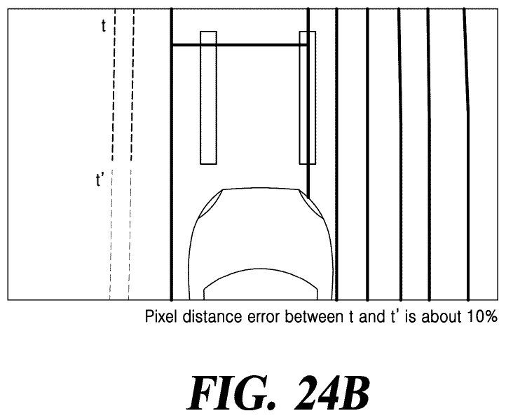

The items 1-4 of Table 1 are described in detail with reference to FIGS. 24-27.

FIGS. 24A and 24B illustrates item 1 in Table 1 of criteria for determining satisfaction of visibility according to an embodiment of the present disclosure.

FIG. 24A shows an example where discontinuities remain uncorrected.

FIG. 24B shows a case where the discontinuities have been corrected; in this case, the pixel distance error between t and t′ has to be about 10%, the adjacent overlapping image region has to be scaled relative to the side view image reference, and the translation/rotation errors between pixels have to be remain within acceptable limits. If the conditions above are satisfied, the correction result may be considered to satisfy the visibility conditions.

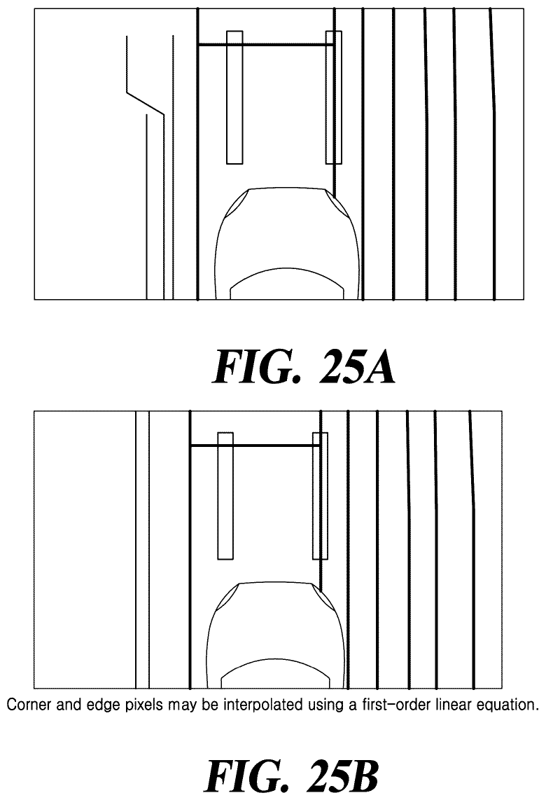

FIGS. 25A and 25B illustrates item 2 in Table 1 of criteria for determining satisfaction of visibility according to an embodiment of the present disclosure.

FIG. 25A shows an example where discontinuities remain uncorrected. FIG. 25B shows a case where the discontinuities have been corrected. In this case, the same corner and edge pixels are detected, and continuities have to be consistent during the linear interpolation after the corner/edge pixels of the adjacent overlapping regions are detected. The corner and edge pixels may be interpolated using a first-order linear equation. If the conditions above are satisfied, the correction result may be considered to satisfy the visibility conditions.

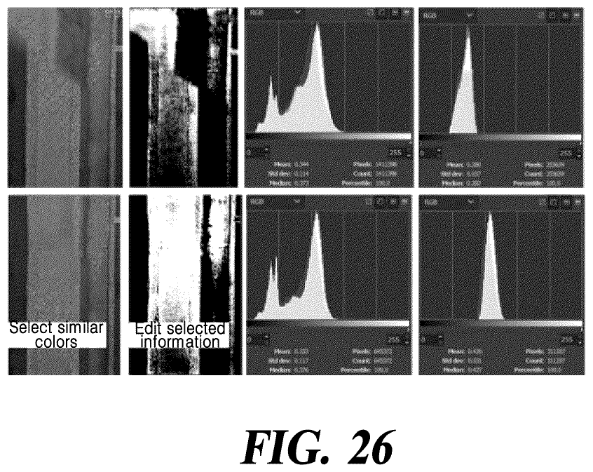

FIG. 26 illustrates item 3 in Table 1 of criteria for determining satisfaction of visibility according to an embodiment of the present disclosure.

FIG. 26 shows an example of selecting a range for similar colors/an example of full histogram/an example of a partial histogram.

The upper drawing of FIG. 26 shows a case where discontinuities remain uncorrected. The lower drawing of FIG. 26 shows a case where the discontinuities have been corrected; in this case, the error for each RGB channel has to be less than about 10%, color tones of adjacent overlapping image regions have to be consistent, and the errors during extraction of RBG properties have to be remain within acceptable limits. If the conditions above are satisfied, the correction result may be considered to satisfy the visibility conditions.

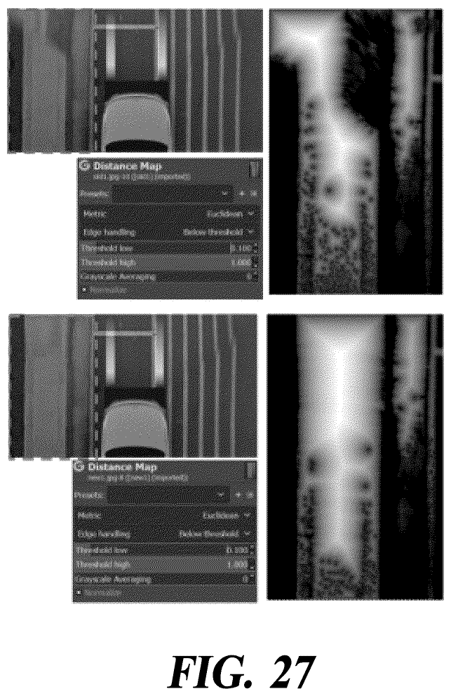

FIG. 27 illustrates item 4 in Table 1 of criteria for determining satisfaction of visibility according to an embodiment of the present disclosure.

FIG. 27 shows an example of generating a distance map through threshold 0.1:1 handling.

The upper drawing of FIG. 27 shows a case where discontinuities remain uncorrected. The lower drawing of FIG. 27 shows a case where the discontinuities have been corrected. In this case, the distance error has to be less than about 10%, and differences of distance maps after the image correction in the adjacent overlapping region have to be remain within acceptable limits. If the conditions above are satisfied, the correction result may be considered to satisfy the visibility conditions.

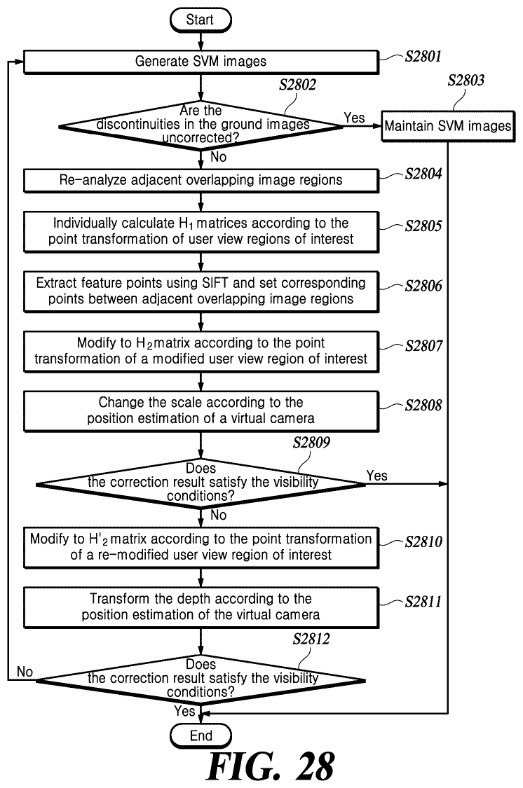

FIG. 28 is a flow diagram illustrating a method for correcting distortions of an image according to an embodiment of the present disclosure.

The image distortion correction apparatus generates a Surround View Monitoring (SVM) image in S2801. The SVM image refers to the AVM image.

The image distortion correction apparatus generates camera image data from input camera image signals captured by cameras installed at a plurality of positions around the vehicle (e.g., positions designated to capture the front, rear, left, and right sides of the vehicle, respectively) and stores the generated camera image data in a storage unit. The cameras according to an embodiment of the present disclosure may be implemented as wide-angle cameras having a field of view of, for example, 180 degrees or more to capture the vehicle's surroundings using as few cameras as possible.

The image distortion correction apparatus synthesizes AVM image data, which is a top view image as if seen from above the vehicle, using the real-time camera image data stored in the storage unit. For example, the image distortion correction apparatus transforms images captured by cameras installed on the front, rear, left, and right sides of the vehicle and looking in the horizontal direction parallel to the ground into images as if captured by cameras looking vertically downward to the ground; the specific process of generating AVM image data using the transformed images will be omitted.

In S2802, the image distortion correction apparatus determines whether the discontinuities in the ground images remain uncorrected.

If discontinuity correction has not been applied to the ground images (YES in S2802), the image distortion correction apparatus maintains the SVM image in S2803.

If discontinuity correction is applied to the ground images (NO in S2802), the image distortion correction apparatus re-analyzes the images of adjacent overlapping regions in S2804.

The image distortion correction apparatus individually calculates the H₁ matrices according to the point transformation of user view regions of interest in S2805. The user view region of interest refers to an image region with discontinuities. Since transforming the entire image requires a lot of computational resources, the H₁ matrices are calculated individually for the user view regions of interest.

The image distortion correction apparatus extracts feature points using Scale Invariant Feature Transform (SIFT) in S2806 and sets corresponding points between adjacent overlapping image regions.

In S2807, the image distortion correction apparatus modifies H₁ matrix into H₂ matrix according to the point transformation of a modified user view region of interest based on a predetermined surface (reference surface or ground). Modifying H₁ matrix into H₂ matrix means transforming a 3D (Dimension) image into a 2D image.

The image distortion correction apparatus changes the scale according to the position estimation of a virtual camera in S2808.

The image distortion correction apparatus determines whether the correction result satisfies the visibility conditions in S2809. If YES in S2809, the method ends.

If NO in S2809, the image distortion correction apparatus modifies H₂ matrix to H′₂ matrix according to the point transformation of a re-modified user view region of interest in S2810. Modifying H₂ matrix to H′₂ matrix means transforming a 2D image into a 2D image with modified corresponding points. Discontinuities due to height differences may be incorrectly estimated, and target objects causing the height differences change in real-time, resulting in increased errors; therefore, the image distortion correction apparatus modifies H₂ matrix to H′₂ matrix.

The image distortion correction apparatus transforms the depth according to the position estimation of the virtual camera in S2811.

The image distortion correction apparatus determines whether the correction result satisfies the visibility conditions in S2812. If YES in S2812, the method ends. If NO in S2812, the method returns to S2801.

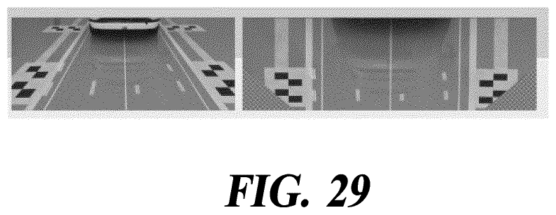

FIG. 29 illustrates an example of transforming a ground plane reference according to an embodiment of the present disclosure.

The left drawing of FIG. 29 shows the ground image according to the conventional method. The right drawing of FIG. 29 shows an example of transforming the ground plane reference in the same manner as the conventional method.

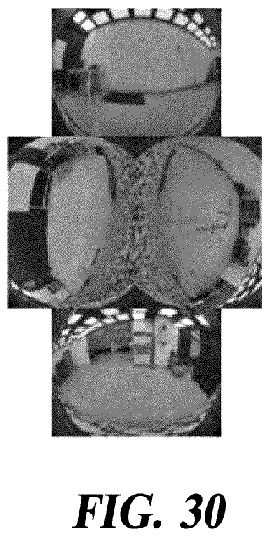

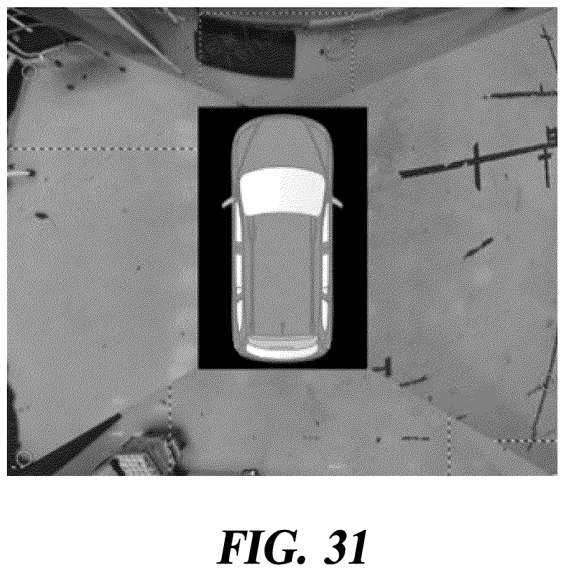

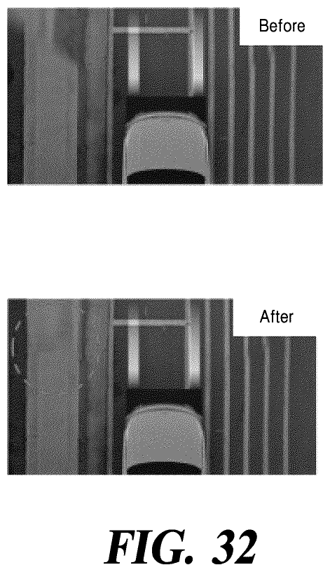

FIG. 30 illustrates the original front/rear/left/right images. FIG. 31 illustrates an example of an AVM image corrected for the effects of discontinuities. FIG. 32 illustrates a case of a front top-view image where the original front/rear/left/right images and AVM image are corrected for the distortions due to discontinuities.

Referring to FIG. 32, in the case of a front top-view image, it may be confirmed that discontinuities in the front image may be corrected when the image distortion correction method according to an embodiment of the present disclosure is applied.

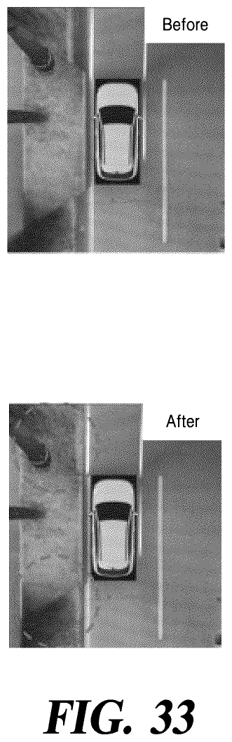

FIG. 33 illustrates a case of a common/3D top view image where the original front/rear/left/right images and AVM image are corrected for the distortions due to discontinuities.

Referring to FIG. 33, in the case of a common/3D top view image, it may be confirmed that discontinuities in the front and rear images may be corrected when the image distortion correction method according to an embodiment of the present disclosure is applied.

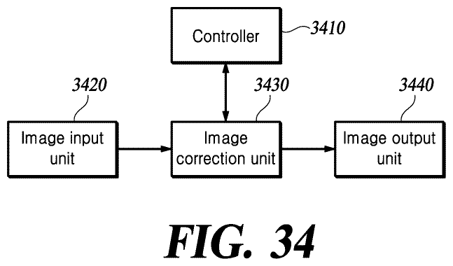

FIG. 34 is a block diagram of an image distortion correction apparatus according to an embodiment of the present disclosure.

The image distortion correction apparatus according to an embodiment of the present disclosure includes a controller 3410, an image input unit 3420, an image correction unit 3430, and image output unit 3440.

The controller 3410 controls each of the image input unit 3420, the image correction unit 3430, and the image output unit 3440 to correct the image distortions according to an embodiment of the present disclosure.

The image input unit 3420 uses one or more cameras to capture images of the front, rear, left, and right sides, respectively, and synthesizes the captured images to generate top view images. In other words, the image input unit 3420 performs the operation of S2801 of FIG. 28.

When discontinuities occur, the image correction unit 3430 corrects the top view images generated by the image input unit 3420 using the method according to an embodiment of the present disclosure. In other words, the image correction unit 3430 performs the operations of S2802-S2812 of FIG. 28.

The image output unit 3440 displays the corrected image.

Although not shown in FIG. 34, the image distortion correction apparatus according to an embodiment of the present disclosure may further include a storage unit that stores the generated top view images and their corrected images.

When discontinuities are present due to height differences, such as a road curb or an obstacle, in an omnidirectional 3D image or a magnified 2D image of a specific area (front/rear top view) obtained by editing the front, side (left/right), and rear wide-angle camera images, AVM images display error components; however, since the present disclosure generates AVM images with respect to the ground plane coordinate system, further corrections may not be required.

Accordingly, the present disclosure focuses on the discontinuity correction editing during the image post-processing step to correct errors in the visibility and provides AVM images with improved image registration.

The present disclosure employs the existing image transformation when the imaging conditions are favorable to the ground plane coordinate system while discontinuity correction according to an embodiment of the present disclosure is applied only to the adverse situation which requires the ground plane offset coordinate system.

At least some of the components described in embodiments of the present disclosure may be implemented as hardware elements, including at least one of a digital signal processor (DSP), a processor, a controller, an application-specific IC (ASIC), a programmable logic device (e.g., FPGA, and the like), and other electronic devices, or a combination thereof. Furthermore, at least some of the functions or processes described in embodiments of the present disclosure may be implemented as software, and the software may be stored in a recording medium. At least some of the components, functions, and processes described in embodiments of the present disclosure may be implemented as a combination of hardware and software.

Methods according to embodiments of the present disclosure may be written as a program which may be executed on a computer, and may also be implemented in various recording mediums such as a magnetic storage medium, an optical read medium, a digital storage medium, and the like.

Implementations of the various techniques described herein may be realized by digital electronic circuitry, or by computer hardware, firmware, software, or combinations thereof. Implementations may be made as a computer program tangibly embodied in a computer program product, i.e., an information carrier, e.g., machine-readable storage device (computer-readable medium) or a radio signal, for processing by or for controlling the operation of a data processing device, e.g., a programmable processor, a computer, or multiple computers. Computer programs, such as the computer program(s) described above, may be written in any form of programming language, including compiled or interpreted languages, and may be deployed in any form as a stand-alone program or as a module, component, subroutine, or other units suitable for use in a computing environment. The computer program may be deployed to be processed on one computer or multiple computers at one site or distributed across multiple sites and developed and interconnected through a communications network.

Processors suitable for processing computer programs include, for example, both and special-purpose microprocessors, and any one or more processors of any type of digital computer. A processor will receive instructions (i.e., computer-executable instructions or commands) and data from read-only memory or random access memory, or both. Elements of the computer may include at least one processor that executes instructions and one or more memory devices that store instructions and data. In general, the computer may include one or more mass storage devices that store data, such as magnetic disks, magneto-optical disks, or optical disks, or may be coupled to the mass storage devices to receive data therefrom and/or transmit data thereto. Information carriers suitable for embodying computer program instructions and data include, for example, semiconductor memory devices, magnetic mediums such as hard disks, floppy disks, and magnetic tapes, optical mediums such as Compact Disk Read Only Memory (CD-ROM), Digital Video Disk (DVD), magneto-optical mediums such as floptical disk, Read-Only Memory (ROM), Random Access Memory (RAM), flash memory, Erasable Programmable ROM (EPROM), and Electrically Erasable Programmable ROM (EEPROM). The processor and memory may be supplemented by or included in special purpose logic circuitry.

Furthermore, the term related to a control device such as “controller”, “control apparatus”, “control unit”, “control device”, “control module”, “control circuit”, or “server”, and the like, refers to a hardware device including a memory and a processor configured to execute one or more steps interpreted as an algorithm structure. The memory stores algorithm steps, and the processor executes the algorithm steps to perform one or more processes of a method in accordance with various embodiments of the present disclosure. The control device according to embodiments of the present disclosure may be implemented through a nonvolatile memory configured to store algorithms for controlling operation of various components of a vehicle or data about software commands for executing the algorithms, and a processor operatively connected to the memory and configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in embodiments of the present disclosure.

In various embodiments of the present disclosure, each operation described above may be performed by a control device, and the control device may be configured by a plurality of control devices, or an integrated single control device.

In various embodiments of the present disclosure, the memory and the processor may be provided as one chip, or provided as separate chips.

In various embodiments of the present disclosure, the scope of the present disclosure includes software or machine-executable commands (e.g., an operating system, an application, firmware, a program, and the like) for enabling operations according to the methods of various embodiments to be executed on an apparatus or a computer, a non-transitory computer-readable medium including such software or commands stored thereon and executable on the apparatus or the computer.

In various embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, and the like, included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, and the like.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of embodiments with reference to the positions of such features as displayed in the figures. It should be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In an embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an embodiment of the present disclosure, components may be combined with each other to be implemented as one, or some components may be omitted.

The foregoing descriptions of specific embodiments of the present disclosure have been presented for purposes of illustration and description. They are not intended to be exhaustive or to limit the present disclosure to the precise forms disclosed, and many modifications and variations are possible in light of the above teachings. Embodiments were chosen and described in order to explain certain principles of the disclosure and their practical application, to enable to those having ordinary skill in the art to make and utilize various embodiments of the present disclosure, as well as various alternatives and modifications thereof. It is intended that the scope of the present disclosure be defined by the Claims appended hereto and their equivalents.

What is claimed is:

1. A method for correcting distortions of an image, the method comprising:
generating Around View Monitoring (AVM) image data from images input from two or more cameras installed around a vehicle;
determining whether adjacent overlapping regions due to discontinuities exist in the AVM image data;
determining a first homography matrix according to a point transformation of a user region of interest (ROI) based on a predetermined point, based on the adjacent overlapping regions existing in the AVM image data;
modifying the first homography matrix to a second homography matrix according to a point transformation of a modified user ROI based on the predetermined point;
determining whether visibility conditions are satisfied according to a modification result; and
modifying the second homography matrix to a third homography matrix according to a re-modified user ROI based on the predetermined point, based on the visibility conditions not being satisfied.

2. The method of claim 1, wherein the adjacent overlapping regions are a boundary region between an image of a front wide-angle camera and an image of a left wide-angle camera of the vehicle, a boundary region between the image of the front wide-angle camera and an image of a right wide-angle camera, a boundary region between an image of a rear wide-angle camera and the image of the left wide-angle camera, and a boundary region between the image of the rear wide-angle camera and the image of the right wide-angle camera; and
wherein the predetermined point and a point of the user ROI are the same object in images captured by different cameras.

3. The method of claim 1, wherein modifying the first homography matrix to the second homography matrix includes changing a scale based on a position estimation of a virtual camera.

4. The method of claim 1, wherein modifying the second homography matrix to the third homography matrix includes adjusting a depth based on a position estimation of a virtual camera.

5. The method of claim 1, wherein determining the first homography matrix is performed by projecting an actual camera image from a user's viewpoint onto a top view image of a virtual camera.

6. The method of claim 5, wherein each pixel of the top view image displayed on a plane is mapped from a corresponding pixel of the actual camera image.

7. The method of claim 2, wherein determining the first homography matrix further includes:
predicting corresponding points for each pixel of the adjacent overlapping regions between adjacent images; and
stitching images from a front view camera and a side view camera based on the predicted corresponding points.

8. The method of claim 1, wherein modifying the first homography matrix to the second homography matrix includes converting a 3D (Dimension) image to a 2D image; and
modifying the second homography matrix to the third homography matrix includes transforming a 2D image to a 2D image with modified corresponding points.

9. The method of claim 3, wherein determining whether the visibility conditions are satisfied includes determining whether an error based on a change of the scale is less than or equal to a predetermined percentage.

10. The method of claim 1, wherein determining whether the adjacent overlapping regions exist includes determining whether differences of gradient values and RGB (Red Green Blue) values between pixels of images captured by a front view camera and a side view camera of the vehicle are less than or equal to a threshold value.

11. An apparatus for correcting distortions of an image, the apparatus comprising:
a memory configured to store computer-executable commands; and
a processor configured to execute the computer-executable commands to:
generate Around View Monitoring (AVM) image data from images input from two or more cameras installed around a vehicle;
determine whether adjacent overlapping regions based on discontinuities exist in the AVM image data;
determine a first homography matrix according to a point transformation of a user region of interest (ROI) based on a predetermined point, based on the adjacent overlapping regions existing in the AVM image data;
modify the first homography matrix to a second homography matrix according to a point transformation of a modified user ROI based on the predetermined point;
determine whether visibility conditions are satisfied according to a modification result; and
modify the second homography matrix to a third homography matrix according to a re-modified user ROI based on the predetermined point, based on the visibility conditions not being satisfied.

12. The apparatus of claim 11, wherein the adjacent overlapping regions are a boundary region between an image of a front wide-angle camera and an image of a left wide-angle camera of the vehicle, a boundary region between the image of the front wide-angle camera and an image of a right wide-angle camera, a boundary region between an image of a rear wide-angle camera and the image of the left wide-angle camera, and a boundary region between the image of the rear wide-angle camera and the image of the right wide-angle camera; and
wherein the predetermined point and a point of the user ROI are the same object in images captured by different cameras.

13. The apparatus of claim 11, wherein, based on the first homography matrix being modified to the second homography matrix, the processor is configured to change a scale based on a position estimation of a virtual camera.

14. The apparatus of claim 11, wherein the processor is configured to adjust a depth based on a position estimation of a virtual camera, based on the second homography matrix being modified to the third homography matrix.

15. The apparatus of claim 11, wherein, based on the first homography matrix being determined, the processor is configured to perform the determination by projecting an actual camera image from a user's viewpoint onto a top view image of a virtual camera.

16. The apparatus of claim 15, wherein each pixel of the top view image displayed on a plane is mapped from a corresponding pixel of the actual camera image.

17. The apparatus of claim 12, wherein, based on the first homography matrix being determined, the processor is configured to predict corresponding points for each pixel of the adjacent overlapping regions between adjacent images and stitch images from a front view camera and a side view camera based on the predicted corresponding points.

18. The apparatus of claim 11, wherein, based the first homography matrix being modified to the second homography matrix, the processor is configured to convert a 3D (Dimension) image to a 2D image, and
based on the second homography matrix being modified to the third homography matrix, the processor is configured to transform a 2D image to a 2D image with modified corresponding points.

19. The apparatus of claim 13, wherein, based on an error due to a change of the scale is less than or equal to a predetermined percentage, the processor is configured to determine that the visibility conditions are satisfied.

20. The apparatus of claim 11, wherein, based on differences of gradient values and RGB (Red Green Blue) values between pixels of images captured by a front view camera and a side view camera of the vehicle are less than or equal to a threshold value, the processor is configured to determine that the adjacent overlapping regions exist.
